(19) United States
(12) Patent Application Publication
(10) Pub. No.: US 2013/0290584 A1
(43) Pub. Date: Oct. 31, 2013

(54) SEQUENCE-BASED PROCESS LOCKING

(71) Applicant: Xiangyang Zhang, San Jose, CA (US)

(72) Inventor: Xiangyang Zhang, San Jose, CA (US)

(73) Assignee: Futurewei Technologies, Inc., Plano, TX (US)

(21) Appl. No.: 13/460,457

(22) Filed: Apr. 30, 2012

(51) Int. Cl. G06F 9/00

(52) U.S. Cl. 710/200

(57) ABSTRACT

Methods, apparatuses, and computer readable media for scheduling operations in a hardware apparatus. A method includes receiving a lock request corresponding to a requested action, and registering a lock corresponding to and in response to the lock request. Registering the lock includes including assigning the registered lock a sequence number. The method includes selecting a current lock based on the sequence number. The method includes permitting the requested action to be performed when the current lock corresponds to the registered lock, and if the registered lock has been requested. The method includes clearing the registered lock.

### TECHNICAL FIELD

The present disclosure relates generally to process scheduling.

### BACKGROUND

Computing power and communication bandwidth requirements continue to increase. As a result, both end users and network service providers have seen the need for faster, more capable systems to maintain adequate performance. In many cases, manufacturers have turned to multicore processors, and many systems also have multiple integrated processors. Each core or processor may support multiple process threads. It can be important to manage the timing of process execution. Improved processes are desirable.

### SUMMARY

In accordance with one embodiment, there is provided a method for scheduling operations in a hardware apparatus. A method includes receiving a lock request corresponding to a requested action, and registering a lock corresponding to and in response to the lock request. Registering the lock includes assigning the registered lock a sequence number. The method includes selecting a current lock based on the sequence number. The method includes permitting the requested action to be performed when the current lock corresponds to the registered lock, and if the registered lock has been requested. The method includes clearing the registered lock.

Other embodiments include various hardware apparatuses and computer readable media configured to perform processes as described herein.

Other technical features may be readily apparent to one skilled in the art from the following figures, descriptions, and claims.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 shows a simplified block diagram of an apparatus in accordance with disclosed embodiments;

FIG. 2 depicts a functional block diagram of a lock mechanism that can be implemented in accordance with disclosed embodiments; and

FIG. 3 depicts a flowchart of a process in accordance with disclosed embodiments.

### DETAILED DESCRIPTION

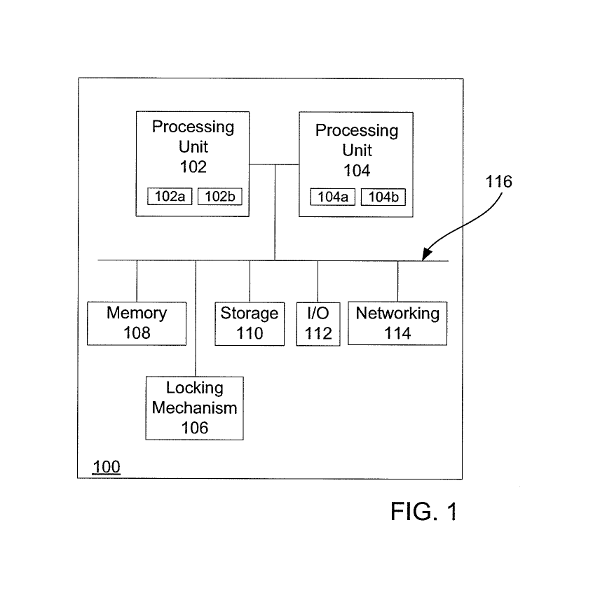

FIGS. 1 through 3, discussed below, and the various embodiments used to describe the principles of the present disclosure are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In high-end computers, including client and server systems, desktop, laptop, and tablet computers, networking appliances, and other systems, it is possible to build a high performance system with the advance of high density multi-core processors. These various types of computers are referred to herein generically as the “computer” or “system”, and a particular apparatus is described below that can represent such a computer. In specific embodiments, the computer performs network processing on packets received from one or more source devices, processes the packets, and retransmits the processed packets to one or more destination devices.

In a networking context, when a computer receives a packet from the source device, the different cores of the computer pick up the incoming packets. The different cores may take different amounts of time to process the packet in the same “flow”, where the packets are received from the same source device. When the packets are transmitted from the computer, the order of the packets may be altered due to the varied intervals of time for each core to process the respective packet, resulting in out-of-order packet transmissions. Disclosed embodiments can manage packet processing so that the packets are retransmitted in the correct order, among other functions.

When the packets are received by the computer, they can be assigned sequence numbers in chronological order. This can be considered similar to making an “appointment” before the actual service is provided. When the packets are retransmitted by the computer, they should be transmitted in the same chronological order based on the sequence numbers. Disclosed embodiments can maintain the proper retransmission order by using a serialized locking mechanism.

Disclosed embodiments can therefore schedule and manage the access of processing threads to shared resources including shared memory or execution on a processor or transmitter.

In a multi-core computing environment, different lock mechanisms can be used to resolve the contention of shared resources and to synchronize the execution of the threads. These can include, for example, spin lock, read-write lock, RCU lock, sequential lock, mutual exclusion (“mutex”), etc., all known to those of skill in the art. None of these methods are efficient or effective in addressing the requirements of thread scheduling to ensure proper packet serialization based on the pre-defined sequence order.

Disclosed techniques can also be used for other cases to perform different synchronized operations. For example, in IPsec applications, the packet can be assigned a unique sequence number based on the time at which it is streamed into a tunnel. In this way, it can efficiently reduce the work load at the receiving side if the packets arrive in order at the destination.

As described herein, a computer can have one or more processors, each of these processors can have one or more processing cores, and each of these cores may process multiple processing threads at any given time. If one core has multiple threads, it may not be costly to block one thread as another thread can immediately take its place to use the computing resource, as described herein. If one core has only one thread, a delayed but ordered operation can also be achieved by using the techniques described below.

Various embodiments include an apparatus and method for ensuring that certain processing is performed in a desired order. The order can be based on the prior event. One common example of a prior event is the time to register this activity, for example, the time at which a packet enters into a network device.

Various disclosed embodiments can reduce the complexity of scheduling due to the introduction of an exclusive lock. The lock is granted by an internal scheduler instead of the overall system scheduler. This separation makes the disclosed locking mechanism easy to be implemented on the chip.

FIG. 1 shows a simplified block diagram of an apparatus 100 in accordance with disclosed embodiments, that can act as the computer or system as described herein. Those of skill in the art will recognize that this hardware implementation is simply one example of a suitable implementation, and does not limit the techniques and processes described herein.

Apparatus 100 includes multiple processors, shown as processing units 102 and 104. Each of the processing units has multiple processing cores; processing unit 102 has processing cores 102a and 102b, and processing unit 104 has processing cores 104a and 104b. While this simplified figure shows two processors each having two cores, those of skill in the art will recognize that disclosed embodiments can be implemented using any number of processors or cores.

In apparatus 100, the processing units 102 and 104 are connected to communicate over a bus 116. Via bus 116, the processing units 102 and 104 can communicate with I/O devices 112, such as displays, sound systems, keyboards, mice, and other human interaction or input/output devices. Via bus 116, the processing units 102 and 104 can communicate with networking devices 114, such as wired or wireless network interfaces, cellular and wide-area network interfaces, and others. Networking devices 114 are capable of receiving and transmitting packets as described herein.

Memory 108 and storage 110 are connected to bus 116, as is locking mechanism 106, which performs functions as described below. Via bus 116, the processing units 102 and 104 can read to and write from memory 108 and storage 110. Memory 108 can be any type of volatile or non-volatile memory, and in particular can be a random-access memory for temporary storage of data being processed, including packets as described herein. Storage 110 can be any type of volatile or non-volatile data storage device, and in particular can be magnetic storage or non-volatile memory such as “flash” memory, and can be used for storing any data as described herein.

Disclosed embodiments include a locking mechanism 106 (or “lock”) that schedules two or more concurrent transactions to access shared data, such as two or more threads operating on processing units 102 or 104 requesting access to common data in a memory 108. The lock is based on a pre-defined sequence, which could be a natural number or in some other order. In various embodiments, this locking mechanism 106 is implemented using a lock container, scheduler, and other components described below.

Locking mechanism 106 can be implemented as a separate controller connected to bus 116, can be implemented as separate processes running on one or more of the processing units, or can be integrated with the memory 108 or storage 110. While the implementations may differ, locking mechanism 106 can schedule and manage access to shared data in memory 108 and storage 110, and can schedule thread processing by processing units 102 and 104.

Various embodiments have two major processes. The first process is to register the lock, which causes the sequence number to be assigned. The second process is to acquire the lock by requesting the lock with the assigned sequence number. The lock is granted when it is its turn based on the sequence number. Thus all of the actions are serialized based on the pre-defined sequence. In order to prevent a case where a lock goes unused after the lock is registered, a timeout mechanism is also provided to guard against deadlock so that the “missing” sequence number can be skipped.

The lock mechanism 106 can serialize the access of shared data by multiple threads, which substantially eliminates or reduces the extra system burden of scheduling and managing the locks.

One aspect to note is that lock mechanism 106 can ensure that threads execute in the order in which a lock is registered, even and in particular if that order is different from when the execution of the locked thread is requested. That is, an incoming packet or executing process may register the lock in the order in which the memory access, packet transmission, or other process should take place. Even if the various threads request the lock out-of-order, the lock mechanism can ensure that the threads execute their processes in the correct sequence.

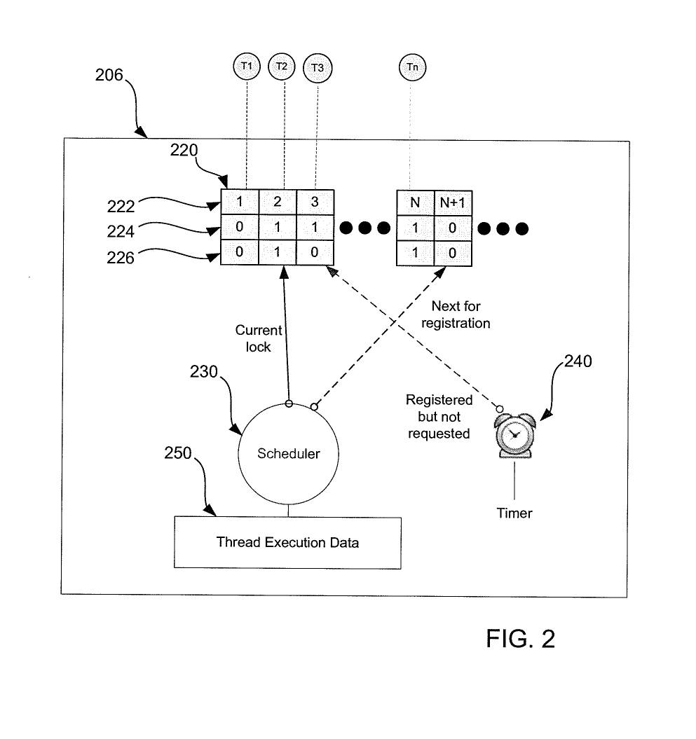

FIG. 2 depicts a functional block diagram of a lock mechanism 206 that can be implemented in apparatus 100, in accordance with disclosed embodiments. In implementations where the lock mechanism 206 is implemented by a separate controller, it can naturally begin functioning as soon as the apparatus 100 begins functioning, or whenever it is activated by software or a user. Similarly, in implementations where the lock mechanism 206 is implemented as a software process on apparatus 100, it can be created or instantiated at the startup of apparatus 100, or whenever it is activated by software or a user.

The lock mechanism 206 includes a number of components. Lock mechanism 206 is responsible for managing and scheduling individual registered locks in lock container 220.

The lock queue or container 220 can contain any number of locks. In various embodiments, the lock container 220 includes a number of fields that indicate the assignment and status of each sequence number and its associated lock. In this example, the fields are represented by the rows of the container, and each column or “slot” represents a different lock, associated with a different thread T1-Tn, although of course those of skill in the art will recognize that the data structure used for the container 220 can vary in different implementations. In various embodiments, container 220 can be implemented in a circular buffer, ordered linked list, or by other method. In hardware implementations, it may be preferred to have a limited number of locks for easy implementation.

Threads T1-Tn are illustrated here as “outside” of locking mechanism 206, as the threads call the locking mechanism but are not part of the locking mechanism.

In this example, the first row of container 220 stores sequence numbers 222. The sequence number is used to define the processing order of the threads. The sequence number can be in the form of natural numbers as shown in FIG. 2, or otherwise, and can also be wrapped back to the initial value, for example if the sequence number reaches the highest number. The sequence number can also be in an arithmetic sequence or in other forms. Lock mechanism 206 can include a generation function to generate sequence numbers. Any sequence can be used, including sequential numbers, even or odd numbers, order numbers, a Fibonacci sequence, or otherwise.

The second row of container 220 stores a “registration indicator” 224, as a flag bit or otherwise, that indicates whether the lock for the corresponding sequence number has been registered. The third row stores a “request indicator” 226, as a flag bit or otherwise, that indicates whether the lock for the corresponding sequence number has been requested by the corresponding thread to be executed.

In this simple example, thread T1 had sequence number 1, and may have already executed (since the current lock is now on thread T2). When thread T1 has completed its operation, it can clear the registration indicator and request indicator to “clear” the registration. In various embodiments, this column or entry can be cleared or flushed since it will no longer be needed.

Thread T2 has sequence number 2, has registered and requested the lock, and is the current lock. Thread T2 is free to execute. Thread T3 has sequence number 3, and has registered the lock but has not requested it.

Thread Tn has registered and requested the lock with sequence number N, but is not yet the current lock.

The sequence numbers 222 can be pre-defined, or can be generated by apparatus 100 or other processes, so long as they properly define the order in which the respective threads should complete their operation.

Lock scheduler 230 is the process that maintains the status of the lock container 220 and determines which thread should receive the current lock and be scheduled to execute. As shown by the arrows in FIG. 2, lock scheduler 230 points to the current lock (solid arrow) and to the next lock available for registration (dashed arrow); this can be implemented using standard pointers or otherwise. In implementations where the respective threads clear the registration after each process has executed, lock scheduler 230 can treat the cleared registration as an indication to move the current lock pointer to the next lock.

Timer 240 prevents the stall of the lock queue. Timer 240 can track threads (or sequence numbers) that have registered a lock but have not requested it, and which are the current lock indicated by lock scheduler 230. If one thread does not request the lock after registration, it may block all the successive threads from obtaining the lock. If the current lock is registered but not requested, the timer will delay for a predetermined or user-configurable time before “timing out” that thread and indicating that the lock scheduler 230 should move to the next sequence number. This prevents a “hang”.

Timer 240 can be started any time the lock scheduler 230 selects a “current lock” that has been registered but not requested by the thread. The timer can be cancelled if the request is received during the predetermined interval of time. If the timer expires, the lock scheduler 230 can mark the “hung” thread as invalid, and move the “current lock” pointer to the next thread in sequence.

A similar timeout process can be used if a process thread is granted a lock but never clears the registration, to ensure that there is no “hang” caused by a failed process. In this case, if the timer expires, the lock scheduler 230 can mark the permitted “hung” thread as invalid, and move the “current lock” pointer to the next thread in sequence.

After the lock mechanism 206 is active, any thread can use the sequence locks. Various embodiments generally perform four processes in normal mode. Each thread registers the sequence lock (and the lock mechanism 206 receives the registration). Registering the sequence lock is similar to making an appointment to use this sequence lock. After the sequence lock is registered, the lock becomes a valid sequence lock and is placed in the lock container 220.

Each thread requests the sequence lock (and the lock mechanism 206 receives the request). That is, it requests permission from the locking mechanism 206 to perform a certain action or get exclusive ordered access to the shared data in memory.

Each thread performs its action or data access when the lock mechanism 206 indicates that it has the current lock. The action can include any operation by the thread, and in particular can include access to shared resources such as shared memory or storage, and in various embodiments can include access to a shared packet transmitter, where the scheduling mechanism is scheduling a packet-transmission action so that packets are transmitted in proper order.

Each thread can release the sequence lock, and the lock mechanism 206 can receive and process the release. Then the lock mechanism can move the “current lock” pointer to the next thread in the sequence, which will generally correspond to the next thread that requested a lock registration.

The action can be performed immediately after the lock request is granted. This requires the thread to wait for the lock, and to respond promptly when the lock is granted. Some embodiments also provide a “fast mode” to prevent delays between a lock request, the granting of “current lock” status, and the response of the thread to actually execute its action. In fast mode, the threads also register the actions at the time of requesting the lock; that is, the threads register that actual process or memory access to be performed, along with any necessary data to complete the process and return the proper result. This data can be stored in the thread execution data 250. The threads automatically request the action at that time, so both the registration flags and request flags are active. As soon as that sequence number is granted to the current lock, the action is completed by the lock scheduler on behalf of the thread. In this “fast mode” case, the sequence lock is automatically released by the lock scheduler when the action is completed.

In the locking mechanism 206, lock scheduler 230 determines which thread takes the turn to obtain the lock. A scheduler as described herein is light-weight and can perform some tasks. It receives the lock requests from different threads, and unblocks each thread when the thread's sequence number equals the current sequence number.

In hardware-implemented embodiments, scheduler 230 and timer 240 can be implemented using a dedicated controller or other processor in the scheduling mechanism. Similarly, lock container 220 and thread execution data 250 can be implemented in a dedicated memory, or can be implemented using shared memory of the apparatus in which the scheduling mechanism is installed.

Conventional thread-locking processes have a significant drawback in that each thread must repeatedly or constantly check to see if it is permitted to execute or access the shared resource. The thread must repeatedly attempt to “grab” the lock to see if it is possible to execute. If it is not, the thread must release the lock. Then it tries to grab the lock again. In such other implementations, the system scheduler takes unnecessary time to switch the threads. By contrast, a locking mechanism as disclosed herein improves the lock performance by eliminating the unnecessary constant-recheck loop performed by each thread. A locking mechanism as disclosed herein can also be readily implemented in hardware as the scheduling task is not complex.

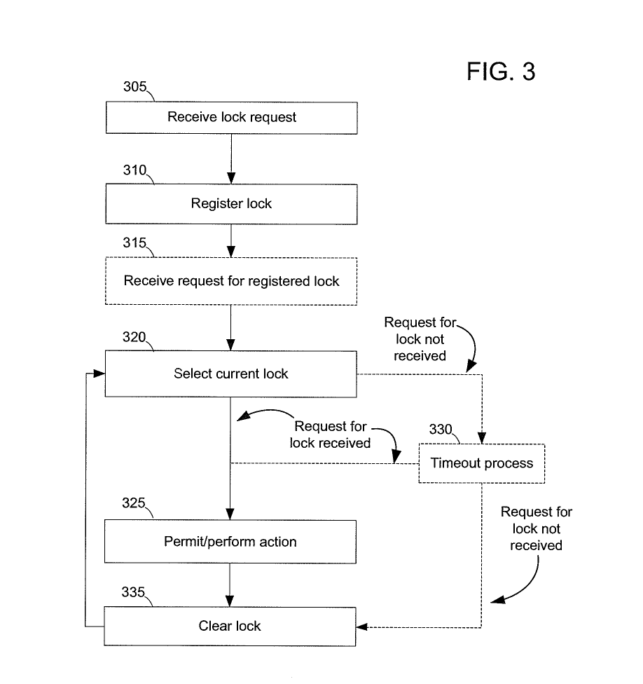

FIG. 3 depicts a flowchart of a process in accordance with disclosed embodiments, as may be performed by a locking mechanism operating on an apparatus as described herein.

The locking mechanism receives a lock request from or corresponding to a processing thread (step 305). The lock request corresponds to a requested action, and can be a request to perform an action. The action can include accessing a shared resource such as a shared memory or storage, to transmit a packet, or other processor actions.

The locking mechanism registers the lock (step 310). This step can include assigning a sequence number to the request and returning the sequence number in response to the request. This step can include assigning a slot corresponding to the request to a lock container, and indicating in the assigned slot that the lock has been registered. In a “fast mode”, this step can include the locking mechanism receiving and storing thread execution data.

In a network device embodiment, for example, the requested action can be a packet transmission, and the sequence number can correspond to a proper sequence for transmitting a related packet. In general, the locking mechanism assigns sequence numbers to a plurality of lock requests, and the sequence numbers correspond to the order in which corresponding requested actions should be performed.

The locking mechanism can receive a request for the registered lock (step 315). This request can be from the processing thread. This step can include indicating in the assigned slot that the lock has been requested. In the “fast mode”, the locking mechanism can also treat the lock request as the request for the registered lock.

The locking mechanism selects a current lock (step 320). This step can include selecting each of a plurality of registered locks in the lock container in order according to the assigned sequence numbers. This step can be performed, for example, after each time that a processing thread performs its requested action.

When the current lock is the registered lock, and the registered lock has been requested, the action corresponding to the registered lock is permitted to be performed (step 325). This step can include the locking mechanism permitting the processing thread to perform the action, or, in a “fast mode”, can include the locking mechanism performing the action itself using the thread execution data.

If the current lock is the registered lock, but a request for the registered lock has not been received, the locking mechanism performs a timeout process (step 330). The timeout process can include invalidating the registered lock if no request for the registered lock is received within a predetermined time; invalidating the registered lock can include clearing the lock as shown in step 335. If the request for the registered lock is received within the predetermined time, the process can continue at step 325.

The registered current lock is cleared (step 335). This step can be performed by the requesting processing thread, for example when the action is complete, or can be performed by the locking mechanism in cases where the execution times out or where the locking mechanism performs the action itself.

The system returns to step 320 to select a new current lock.

Note that unless otherwise specifically indicated or required by the logical operations, the steps above can be performed sequentially, concurrently, repeatedly, or in a different order, or various steps can be omitted. In particular, the process above can be an ongoing, repeated process, so that the locking mechanism is constantly performing the processes of registering locks, receiving requests for locks, choosing current locks, and performing the other processes described above. The various elements described herein can be arranged in any number of ways, and can be combined into still other embodiments.

A locking mechanism as disclosed herein is particularly useful in network devices to maintain the correct packet order, especially in a multi-core computing environment. When the packets enter into the network device in chronological order, they could leave out of the device in different order due to varied intervals of processing times by different cores, and therefore arrive at their destination out of the sending order. Some destination applications and devices would otherwise waste computing resources to rearrange the packets into the original order.

For example, if TCP segments are received out of order (meaning, non-contiguously), the socket interface needs to buffer and reorder the segments. Of course, TCP protocol can use an ACK mechanism to guarantee the order because the next segment will not be sent out until the receiving side ACKs the previous one. But for the technique like delayed acknowledgement used for the performance improvement, the acknowledgement is not sent out immediately after the packet is received. In this case, it is helpful to keep the packet arrival in order, which could reduce a wasted computing load at the receiving side.

Another example of communications that benefit from a locking mechanism as described herein is an IPsec tunnel. Any packet sent out from one end has one sequence number embedded in an IPsec header. If the packets can arrive in order of sequence number at the other end, it could efficiently reduce the anti-replay window size and work load at the receiving side. So at the sending side, an IPsec module can request the sequence number in fast mode.

Disclosed embodiments include specific technical advantages over other systems. For example, disclosed embodiments describe a new type of lock which is different from locks such as the spin lock, RCU lock and semaphore. The disclosed lock is useful for maintaining the ordered access of the shared resource based on the lock registration. The order can be used for synchronization based on a defined prior event which happens before the lock is requested.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, processor, system, or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method of scheduling operations in a hardware apparatus, the method performed by a locking mechanism and comprising:
receiving a lock request corresponding to a requested action;
registering a lock corresponding to and in response to the lock request, including assigning the registered lock a sequence number;
selecting a current lock based on the sequence number;
when the current lock corresponds to the registered lock, and if the registered lock has been requested, then permitting the requested action to be performed; and
clearing the registered lock.

2. The method of claim 1, wherein the requested action is a packet transmission, and the sequence number corresponds to a proper sequence for transmitting a related packet.

3. The method of claim 1, wherein the locking mechanism assigns sequence numbers to a plurality of lock requests, and the sequence numbers correspond to the order in which corresponding requested actions should be performed.

4. The method of claim 3, wherein the locking mechanism receives a request for the registered lock, and the registered lock is cleared after the corresponding action is performed.

5. The method of claim 1, wherein when the current lock corresponds to the registered lock and the registered lock has not been requested, the locking mechanism performs a timeout process and thereafter clears the registered lock.

6. The method of claim 1, wherein the locking mechanism, operating in a fast mode, receives thread execution data with the lock request and performs the requested action according to the thread execution data.

7. The method of claim 1, wherein the locking mechanism maintains a lock container including a plurality of registered locks, and maintains a scheduling process that indicates which of the registered locks in the lock container is selected as the current lock.

8. An apparatus comprising:
a controller; and
an accessible memory, the apparatus implementing a locking mechanism that is configured to:
receive a lock request corresponding to a requested action;
register a lock corresponding to and in response to the lock request, including assigning the registered lock a sequence number;
select a current lock based on the sequence number;
permitting the requested action to be performed when the current lock corresponds to the registered lock and if the registered lock has been requested; and
clear the registered lock.

9. The apparatus of claim 8, wherein the requested action is a packet transmission, and the sequence number corresponds to a proper sequence for transmitting a related packet.

10. The apparatus of claim 8, wherein the locking mechanism assigns sequence numbers to a plurality of lock requests, and the sequence numbers correspond to the order in which corresponding requested actions should be performed.

11. The apparatus of claim 10, wherein the locking mechanism receives a request for the registered lock, and the registered lock is cleared after the corresponding action is performed.

12. The apparatus of claim 8, wherein the locking mechanism performs a timeout process and thereafter clears the registered lock when the current lock corresponds to the registered lock and the registered lock has not been requested.

13. The apparatus of claim 8, wherein the locking mechanism, operating in a fast mode, receives thread execution data with the lock request and performs the requested action according to the thread execution data.

14. The apparatus of claim 8, wherein the locking mechanism maintains a lock container including a plurality of registered locks, and maintains a scheduling process that indicates which of the registered locks in the lock container is selected as the current lock.

15. A non-transitory computer readable medium encoded with computer-executable instructions that, when executed, cause a controller to:
receive a lock request corresponding to a requested action;
register a lock corresponding to and in response to the lock request, including assigning the registered lock a sequence number;
select a current lock based on the sequence number;
permitting the requested action to be performed when the current lock corresponds to the registered lock and if the registered lock has been requested; and
clear the registered lock.

16. The computer readable medium of claim 15, wherein the requested action is a packet transmission, and the sequence number corresponds to a proper sequence for transmitting a related packet.

17. The computer readable medium of claim 15, wherein the controller assigns sequence numbers to a plurality of lock requests, and the sequence numbers correspond to the order in which corresponding requested actions should be performed.

18. The computer readable medium of claim 17, wherein the controller receives a request for the registered lock, and the registered lock is cleared after the corresponding action is performed.

19. The computer readable medium of claim 15, wherein the controller performs a timeout process and thereafter clears the registered lock when the current lock corresponds to the registered lock and the registered lock has not been requested.

20. The computer readable medium of claim 15, wherein the controller, operating in a fast mode, receives thread execution data with the lock request and performs the requested action according to the thread execution data.
